(19) United States
(12) Patent Application Publication
(10) Pub. No.: US 2009/0301592 A1
(43) Pub. Date: Dec. 10, 2009

(54) FLUIDIC MODULE CONNECTION

(76) Inventor: Jochen Mueller, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/134,836

(22) Filed: Jun. 6, 2008

(51) Int. Cl. F16K 11/10; F15C 4/00

(52) U.S. Cl. 137/884; 137/833

(57) ABSTRACT

A fluidic module is described, the fluidic module comprising a fluidic connector located at the bottom side of the fluidic module, the fluidic connector comprising a fluid port, wherein, when the fluidic module is placed on top of a further fluidic module, the fluidic connector is in contact with a further fluidic connector of said further fluidic module, and a fluid tight fluidic connection is established between said fluid port and a corresponding fluid port of said further fluidic connector.

### BACKGROUND ART

The present invention relates to a fluidic module with a fluidic connector, to a fluidic system comprising a first and a second fluidic module, and to a fluidic system comprising a rack and a fluidic module.

The Agilent 1200 Series, which is sold by the applicant of the present invention, comprises a range of liquid chromatography systems and modules. In particular, the 1200 Series comprises pumping systems, injection systems, degassers, detectors, controllers, liquid chromatography/mass spectroscopy systems, ionization sources, etc. In the Agilent 1200 series, the fluidic modules are fluidically interconnected by capillaries.

### DISCLOSURE

It is an object of the invention to provide an improved fluidic coupling between fluidic modules or between a fluidic module and a rack. The object is solved by the independent claim(s). Further embodiments are shown by the dependent claim(s).

A fluidic module according to an embodiment of the present invention comprises a fluidic connector located at the bottom side of the fluidic module. The fluidic connector comprises a fluid port. When the fluidic module is placed on top of a further fluidic module, or when the fluidic module is slid onto a further fluidic module, the fluidic connector is in contact with a further fluidic connector of said further fluidic module, and a fluid tight fluidic connection is established between said fluid port and a corresponding fluid port of said further fluidic connector.

By placing a fluidic module on top of a further fluidic module, or by sliding the fluidic module onto a further fluidic module, fluidic interconnections are set up between the fluidic modules. When a user assembles the system, the user does not have to take care about connecting the fluidic connectors. The fluidic connections are automatically set up in a correct way.

A fluidic system according to an embodiment of the present invention comprises a first fluidic module and a second fluidic module. The first fluidic module comprises a first fluidic connector located at the upper side of the first fluidic module, the first fluidic connector comprising a first fluid port. The second fluidic module comprises a second fluidic connector located at the bottom side of the second fluidic module, the second fluidic connector comprising a second fluid port. When the second fluidic module is placed on top of the first fluidic module, the second connector is in contact with the first connector, and the first and the second fluidic connector are adapted for establishing a fluid tight fluidic connection between the first fluid port and the second fluid port.

In this embodiment, when the second fluidic module is placed on top of the first fluidic module, the second fluidic connector is pressed against the first fluidic connector, and thus, the fluidic connections required for the system's operation are set up. The user does not have to join together any kind of capillary fittings. The user does not have to take care about connecting the fluidic connectors. By placing the second fluidic module on top of the first fluidic module, corresponding fluidic connectors are brought in contact with each other, and thus, the fluidic connections are automatically set up in a correct way. Hence, the present inventions provides a foolproof technique for fluidically connecting two or more fluidic modules.

According to a preferred embodiment, the second fluidic connector is implemented as a counterpart of the first fluidic connector. The second fluidic connector may e.g. engage with the first fluidic connector when the fluidic connectors get in contact with each other. Preferably, the second fluidic connector is a complementary connector to the first fluidic connector.

According to a preferred embodiment, when the second fluidic module is placed on top of the first fluidic module, the first and the second fluidic connector are adapted for automatically establishing a fluid tight fluidic connection between the first fluid port and the second fluid port. In this embodiment, the user does not have to manually establish a fluidic connection between the first and the second fluidic module. By placing the second fluidic module on top of the first fluidic module, the fluidic connections required for operation of the fluidic system are set up automatically. It is simply not possible to set up the fluidic connections in a wrong manner. Hence, a convenient and fool-proof fluidic interconnection technique is provided.

According to a preferred embodiment, the fluid tight fluidic connection is accomplished by a contact pressing force that presses the second fluidic connector of the second fluidic module against the first fluidic connector of the first fluidic module. The contact pressing force has to be sufficiently large to prevent leakage of the fluidic connection.

According to a preferred embodiment, the contact pressing force is exerted by the second fluidic module's weight. The second module's weight presses the second fluidic connector against the first fluidic connector, whereby the fluidic connection between the first and the second fluidic connector is tightened.

According to a preferred embodiment, at least one of the first and the second fluidic module comprises a clamping member adapted for pressing the second fluidic module against the first fluidic module.

According to a preferred embodiment, at least one of the first and the second fluidic module comprises a clamping member, wherein a clamping force exerted by the clamping member is adapted for pressing the second fluidic connector of the second fluidic module against the first fluidic connector of the first fluidic module. When the respective clamping member (e.g. a buckle) is fastened, the second fluidic connector is tightly pressed against the first fluidic connector. The contact pressing force produced by the clamping member is sufficiently large for sealing the fluidic connection between the fluidic connectors.

According to a preferred embodiment, the fluid tight fluidic connection is fluid tight at a fluid pressure of up to 1500 bar. In a further preferred embodiment, at least one of the fluidic connectors comprises a sealing element, preferably a rubber gasket, located around the fluid port of said at least one fluidic connector. Preferably, the fluidic connectors are substantially made of one or more of: PEEK, ceramics, teflon. According to a preferred embodiment, at least one of the fluidic connectors comprises a sealing face. Preferably, the sealing face is made of one of: PEEK, ceramics, teflon.

According to a preferred embodiment, one of the fluidic connectors is realized as a protrusion, and a corresponding fluidic connector of the respective other fluidic module is realized as a complementary indentation adapted for accepting the protrusion. Preferably, the protrusion engages with the complementary indentation when the second fluidic module is placed on top of the first fluidic module. For example, the protrusion may be caught by the indentation when the second fluidic module is placed on top of the first fluidic module.

According to a preferred embodiment, at least one of the fluidic connectors comprises a guide sleeve. For example, the guide sleeve may be helpful for aligning the first fluidic connector. When the second fluidic connector is pressed against the first fluidic connector, the guide sleeve may be helpful for aligning the fluidic connectors, for leading the first fluidic connector towards the second fluidic connector. Thus, it is made sure that the fluid port of the first fluidic connector is properly aligned with the fluid port of the second fluidic connector, to provide for a reliably fluidic connection between the two fluidic connectors. Preferably, the guide sleeve is realized as a self-aligning guide sleeve. In a preferred embodiment, the guide sleeve of a fluidic connector is adapted for being caught by a corresponding fluidic connector of the respective other fluidic module. In a preferred embodiment, the guide sleeve of a fluidic connector is laterally movable to adjust to a position of a corresponding fluidic connector of the respective other fluidic module. In this embodiment, the fluidic connector may adjust to the position of the respective other fluidic connector, at least to some extent.

According to a the fluidic connector comprising the guide sleeve further comprises a spring element adapted for pressing the guide sleeve against a corresponding fluidic connector of the respective other fluidic module. The spring element provides some adjustability to the guide sleeve. Preferably, the spring element is one of: a cup spring, a plate spring, a disk spring, a spring collar, a coil spring.

According to an alternative embodiment, a fluidic system according to another embodiment of the present invention comprises a first fluidic module and a second fluidic module. The first fluidic module comprises a first fluidic connector located at the upper side or at the rear side of the first fluidic module, the first fluidic connector comprising a first fluid port. The second fluidic module comprises a second fluidic connector located at the bottom side or at the rear side of the second fluidic module, the second fluidic connector comprising a second fluid port. When the second fluidic module is slid onto the first fluidic module, the second connector is adapted for engaging with the first connector, and the first and the second fluidic connector are adapted for establishing a fluid tight fluidic connection between the first fluid port and the second fluid port.

In this embodiment, when the second fluidic module is slid onto the first fluidic module, the second fluidic connector engages with the first fluidic connector, and thus, the fluidic connections required for the system's operation are set up. The user does not have to join together any kind of capillary fittings. By sliding the second fluidic module onto the first fluidic module, corresponding fluidic connectors engage with each other, and the fluidic connections are automatically set up in a correct way.

According to a preferred embodiment, when the second fluidic module is slid onto the first fluidic module, the first and the second fluidic connector are adapted for automatically establishing a fluid tight fluidic connection between the first fluid port and the second fluid port.

Preferably, the contact pressing force is exerted by a spring element. Further preferably, the spring element is one of: a cup spring, a plate spring, a disk spring, a spring collar, a coil spring.

According to a preferred embodiment, one of the fluidic connectors is realized as a tail of a dovetail joint, and a corresponding fluidic connector of the respective other fluidic module is realized as a socket of the dovetail joint. Preferably, the dovetail joint is assembled by sliding the tail into the socket. Further preferably, the tail comprises a fluid port, the socket comprises a corresponding fluid port, and a fluidic connection is established when the tail engages with the socket. Due to the specific geometry of the dovetail joint, the fluid port of the tail is tightly pressed against the fluid port of the socket when the tail is slid into the socket. According to a preferred embodiment, the dovetail joint is adapted for establishing a fluid tight fluidic connection between the first fluidic module and the second fluidic module when the second fluidic module is slid onto the first fluidic module. The specific geometry of the dovetail joint is well-suited for accomplishing fluid tight fluidic connections.

According to a preferred embodiment, the tail is located at the bottom side of the second fluidic module, the socket is located at the upper side of the first fluidic module, and the tail engages with the socket when the second fluidic module is slid onto the first fluidic module.

According to a alternatively preferred embodiment, the tail is located at the rear side of the second fluidic module and protrudes downwards, the socket is located at the rear side of the first fluidic module, and the tail engages with the socket when the second fluidic module is slid onto the first fluidic module.

According to a preferred embodiment, the socket is slightly tapered towards the rear end of the dovetail joint, and the joint becomes tighter as a finished position is reached. Thus, a tight fitting of tail and socket is accomplished, and the fluidic connections between fluid ports of the tail and fluid ports of the socket are sealed up.

According to a preferred embodiment, the first fluidic module comprises an electrical connector, the second fluidic module comprises an electrical connector, and the electrical connectors are adapted for providing an electrical connection between the second fluidic module and the first fluidic module. According to another preferred embodiment, the first fluidic module comprises an optical connector, the second fluidic module comprises an optical connector, and the optical connectors are adapted for providing an optical connection between the second fluidic module and the first fluidic module. In addition to fluidic connections, electrical connections and/or optical connections may be set up between the fluidic modules. Via the electrical and/or optical transmission paths, data or signals may be exchanged between the fluidic modules.

According to a preferred embodiment, the first and the second fluidic module contain fluidic system components of the fluidic system.

Preferably, the first and the second fluidic module contain fluidic system components of the fluidic system, wherein the fluidic system components may e.g. comprise one or more of: a pump, a pumping system, a preparative pump, a binary pump, a quaternary pump, a degassing unit, an autosampling unit, a purification system, a sample preparation system, a thermostatted column compartment, a sample separation system, a fraction collector, a mass spectroscopy unit, a variable wavelength detector, a multiple wavelength detector, a diode array detector, a fluorescence detector, a refractive index detector.

According to a further preferred embodiment, the fluidic system is one of: a liquid chromatography system, an HPLC system, an electrophoresis system, an electrochromatography system.

A fluidic system according to another embodiment of the present invention comprises a rack adapted for mounting two or more fluidic modules and a fluidic module. The rack comprises a first fluidic connector with a first fluid port. The fluidic module comprises a second fluidic connector located at the bottom side or at the rear side of the fluidic module, the second fluidic connector comprising a second fluid port. When the fluidic module is put in the rack, the second connector is in contact with the first connector, and the first and the second fluidic connector are adapted for establishing a fluid tight fluidic connection between the first fluid port and the second fluid port.

According to this embodiment, the fluidic module is put in a rack, whereby fluidic connections are set up between the fluidic module and the rack. By putting the fluidic module in the rack, the fluidic connections are set up automatically, and the user does not have to care about setting up the fluidic connections any more. In case two or more fluidic modules are put in the rack, the rack may provide the required fluidic interconnections between said two or more fluidic modules.

According to a preferred embodiment, when the fluidic module is put in the rack, the first and the second fluidic connector are adapted for automatically establishing a fluid tight fluidic connection between the first fluid port and the second fluid port.

According to a preferred embodiment, the rack comprises a back panel, the back panel comprising the first fluidic connector. Further preferably, the back panel comprises a fluid conduit adapted for providing a fluidic connection between two or more fluidic modules mounted in the rack. When the two or more fluidic modules are put in the rack, the fluidic connections required for proper operation of the fluidic system are set up automatically.

Preferably, the fluidic system comprises a clamping member adapted for pressing the fluidic module against a back panel of the rack with a certain contact pressing force. Preferably, the contact pressing force is of sufficient magnitude for sealing the fluidic connection between the fluidic connectors.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a second fluidic module that is placed on top of a first fluidic module, whereby a plurality of fluidic connections are established;

FIG. 2 gives another view of the first and the second fluidic module;

FIGS. 3A and 3B show cross-sections of fluidic connectors;

FIG. 4 shows a first and a second fluidic connector, the second fluidic connector comprising a guide sleeve;

FIG. 5A shows a fluidic module with a fluidic connecting piece;

FIG. 5B shows a second fluidic module that is inserted into a first fluidic module;

FIG. 6 shows an embodiment where two fluidic modules are fluidically connected via two dovetail joints;

FIG. 7 shows another embodiment where two fluidic modules are fluidically connected via two dovetail joints; and

FIG. 8 shows a rack together with a fluidic module.

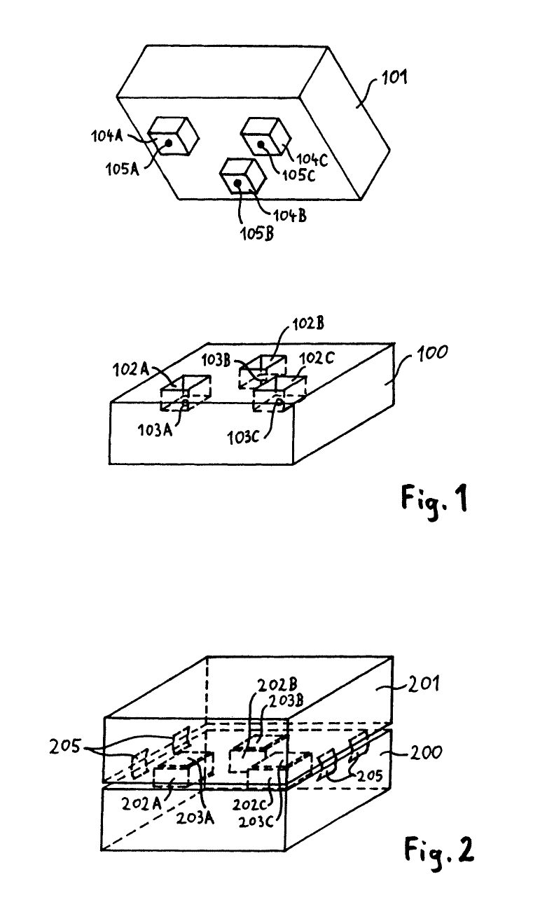

FIG. 1 shows a first fluidic module 100 and a second fluidic module 101, whereby the second fluidic module 101 may be placed on top of the first fluidic module 100. At the upper side of the first fluidic module 100, three fluidic connectors 102A, 102B and 102C are located. Each of the fluidic connectors 102A, 102B, 102C comprises a fluid port 103A, 103B, 103C at the center of the respective fluidic connector. Correspondingly, the second fluidic module 101 comprises three fluidic connectors 104A, 104B, 104C located at the bottom side of the second fluidic module 101, with each of the fluidic connectors 104A, 104B, 104C comprises a respective fluid port 105A, 105B, 105C.

The arrangement of the fluidic connectors 104A, 104B, 104C corresponds to the arrangement of the fluidic connectors 102A, 102B, 102C. Generally, the fluidic connectors 104A, 104B, 104C are realized as counterparts of the fluidic connectors 102A, 102B and 102C. For example, in the embodiment shown in FIG. 1, the fluidic connectors 104A, 104B, 104C are realized as protrusions, whereas the corresponding fluidic connectors 102A, 102B and 102C are realized as indentations. When the second fluidic module 101 is placed on top of the first fluidic module 100, the fluidic connector 104A engages with the fluidic connector 102A, and a fluidic connection is established between the fluid ports 105A and 103A. Correspondingly, the fluidic connectors 104B, 104C engage with the corresponding fluidic connectors 102B, 102C, and fluidic connections are established between the fluid ports 105B and 103B and the fluid ports 105C and 103C. When the second fluidic module 101 is placed on top of the first fluidic module 100, several fluidic connections are automatically set up between the two fluidic modules 100 and 101. Hence, it is no longer necessary to join together any kind of capillary connectors.

Preferably, the fluidic connectors are made of PEEK (polyetheretherketone), ceramics or teflon, or comprise a sealing face made of one of these materials. To provide for fluid-tight fluidic connections between the complementary fluidic connectors, sealing elements like for example rubber gaskets may be placed between corresponding fluidic connectors.

In the embodiment shown in FIG. 1, each of the fluidic connectors 102A, 102B, 102C, 104A, 104B, 104C comprises one fluid port. However, alternatively, each of the fluidic connectors may as well comprise two or more fluid ports, to provide two or more parallel fluidic connections between the fluidic modules.

The fluidic modules 100, 101 may for example be components of a fluidic system, like for example a liquid chromatography system, a HPLC (High Performance Liquid Chromatography) system, an electrophoresis system, an electrochromatography system, or any other kind of sample analysis system. A fluidic module of the system may for example comprise one or more of the following functional units: a pump (for example a preparative pump, a binary pump, a quaternary pump), a degassing unit, an auto-sampling unit, a purification system, a sample preparation system, a thermostated column compartment, a sample separation system, a fraction collector, a mass spectroscopy unit, a detection unit (like for example a variable wavelength detector, a multiple wavelengths detector, a diode array detector, a fluorescence detector, a refractive index detector, an evaporative light scattering detector, also referred to as ELSD, an electrochemical detector).

Although the invention has been developed in the field of sample analysis systems, it is not limited to sample analysis systems. Embodiments of the present invention may be applied to any kind of fluid handling system comprising two or more fluidic modules, with fluidic interconnections being set up between the fluidic modules.

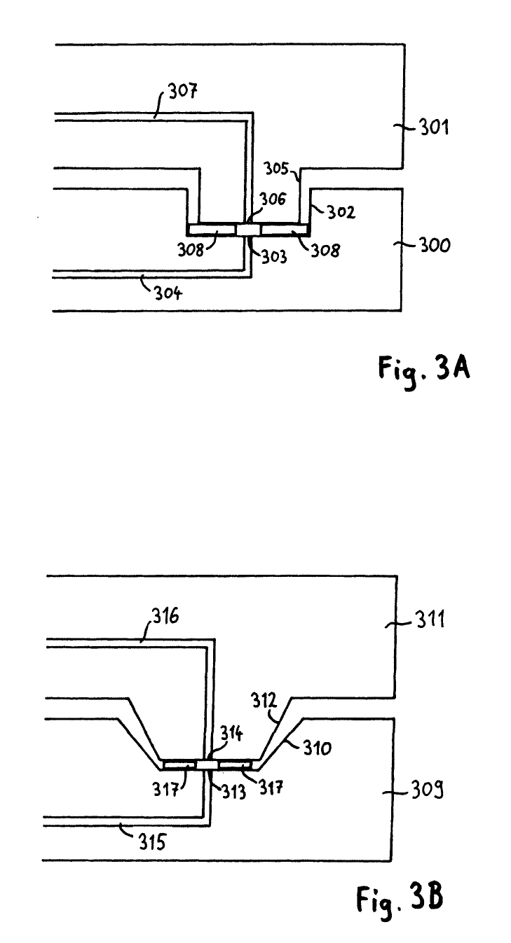

FIG. 2 shows a fluidic system comprising a first fluidic module 200 and a second fluidic module 201, whereby the second fluidic module 201 has been placed on top of the first fluidic module 200. It can be seen that the fluidic connectors 202A, 202B, 202C of the first fluidic module 200 are in engagement with corresponding fluidic connectors 203A, 203B, 203C of the second fluidic module 201. Each of the fluidic connectors comprises one or more fluid ports. For tightening the fluidic connections, the fluidic connectors 203A, 203B, 203C have to be pressed against the corresponding fluidic connectors 202A, 202B, 202C with a certain contact pressing force 204. The contact pressing force 204 has to be sufficiently large for accomplishing fluid-tight fluidic connections even at high fluid pressures, for example at fluid pressures of up to 1500 bar, which are used in nowadays sample analysis systems. According to a first embodiment, the weight of the second fluidic module 201 is sufficiently large to provide a contact pressing force 204 of sufficient magnitude for establishing fluid-tight fluidic connections between the first and the second fluidic module 200 and 201.

According to an alternatively preferred embodiment, at least one of the fluidic modules 200, 201 is equipped with a clamping member adapted for pressing the second fluidic module 201 against the first fluidic module 200. For example, in FIG. 2, the second fluidic module 201 may comprise a set of buckles 205 (indicated with dashed lines). When the buckles 205 are tightened, the second fluidic module 201 is pulled downwards and pressed onto the first fluidic module 200. Thus, fluid-tight fluidic connections are established between the fluidic connectors 202A and 203A, 202B and 203B, and 202C and 203C. Even at high fluid pressures of up to 1500 bar, leakage is avoided.

According to a further alternative embodiment, the system may comprise an actuation mechanism for exerting a contact pressing force 204 that is actuated by a bell crank lever or by a screw.

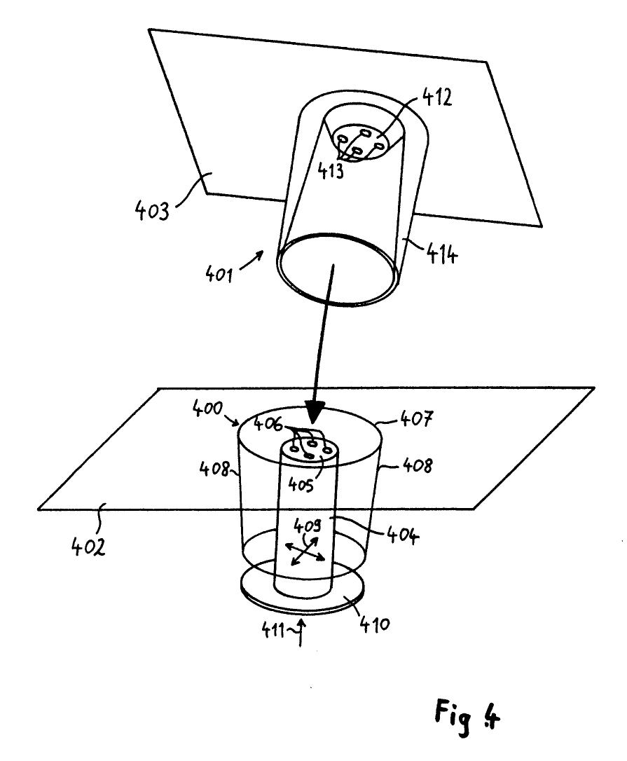

FIG. 3A shows a cross section of a first fluidic module 300 and a second fluidic module 301, whereby the second fluidic module 301 has been placed on top of the first fluidic module 300. The first fluidic module 300 comprises a fluidic connector 302 that is realized as an indentation. A fluid port 303 of the fluidic connector 302 is fluidically connected with a fluid conduit 304. The second fluidic module 301 comprises a fluidic connector 305 that is realized as a protrusion. A fluid port 306 of the fluidic connector 305 is fluidically coupled with a fluid conduit 307. When the second fluidic module 301 is placed on top of the first fluidic module 300, the fluidic connector 305 engages with the corresponding fluidic connector 302. To accomplish a fluid-tight fluidic connection, a rubber gasket 308 is placed between the fluidic connectors 302 and 305. Now, the fluid conduit 304 of the first fluidic module 300 is fluidically coupled, via the fluid ports 303 and 306, with the fluid conduit 307 of the second fluidic module 301. In the embodiment shown in FIG. 3A, the outer diameter of the fluidic connector 305 is smaller than the inner diameter of the fluidic connector 302. This allows for some amount of lateral adjustment of the fluidic connector 305 relative to the fluidic connector 302. No matter how the fluidic connector 305 is exactly positioned relative to the fluidic connector 302, a fluidic connection can be set up between the fluidic connectors 302 and 305. In any case, the rubber gasket 308 provides for a fluid-tight connection.

FIG. 3B shows another embodiment of the present invention. A first fluidic module 309 comprises a fluidic connector 310 located at the upper surface of the first fluidic module 309, with the fluidic connector 310 being realized as an indentation. A second fluidic module 311 comprises a fluidic connector 312 located at the bottom surface of the second fluidic module 311, with the fluidic connector 312 being formed as a protrusion. Each of the fluidic connectors 310, 312 comprises a respective fluid port 313, 314. The fluid port 313 is in fluidic connection with a fluid conduit 315, and the fluid port 314 is fluidically coupled with a fluid conduit 316. The fluidic connector 312 is adapted for engaging with the complementary fluidic connector 310. In contrast to the embodiment shown in FIG. 3A, the fluidic connector 312 is conically tapered towards the base. Correspondingly, the sidewalls of the fluidic connector 310 are bevelled. Because of its conical shape, the fluidic connector 312 is automatically centered relative to the fluidic connector 310 when the second fluidic module 311 is placed on top of the first fluidic module 309. Hence, the conical shape of the fluidic connector 312 gives rise to a self-alignment of the fluidic connector 312 relative to the fluidic connector 310. A sealing element, for example a rubber gasket 317, is put between the fluidic connectors 310, 312 to provide for a fluid-tight fluidic connection between the fluid conduits 315 and 316.

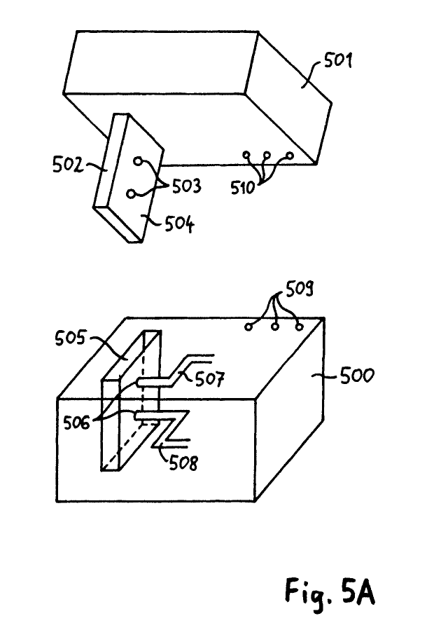

FIG. 4 shows a pair of fluidic connectors 400 and 401. The first fluidic connector 400 may for example be located at an upper surface 402 of a first fluidic module, whereas the second fluidic connector 401 may for example be located at a bottom surface 403 of a second fluidic module. The first fluidic connector 400 comprises an inner connecting piece 404 with a contact surface 405. The contact surface 405 comprises four fluid ports 406. The inner connecting piece 404 is located in a cut-out 407 with bevelled sidewalls 408. To some extent, the inner connecting piece 404 may be moved in a lateral direction, as indicated by arrows 409, to adapt to the position of the second fluidic connector 401. The inner connecting piece 404 may for example be mounted on a spring collar 410 that provides a resilient force 411 for pressing the contact surface 405 against a contact surface 412 of the second fluidic connector 401. The contact surface 412 of the second fluidic connector 401 comprises four fluid ports 413 at locations that correspond to the locations of the fluid ports 406. The second fluidic connector 401 further comprises a guide sleeve 414 that is adapted for engaging with the interspace between the inner connecting piece 404 and the cut-out 407 of the first fluidic connector 400. When the second fluidic module is pressed against the first fluidic module, the guide sleeve 414 is caught by said interspace, and the second fluidic connector 401 is aligned with the first fluidic connector 400. The contact surface 405 is tightly pressed against the contact surface 412, and fluid-tight fluidic connections are established between the fluid ports 406 of the first fluidic connector 400 and the fluid ports 413 of the second fluidic connector 401.

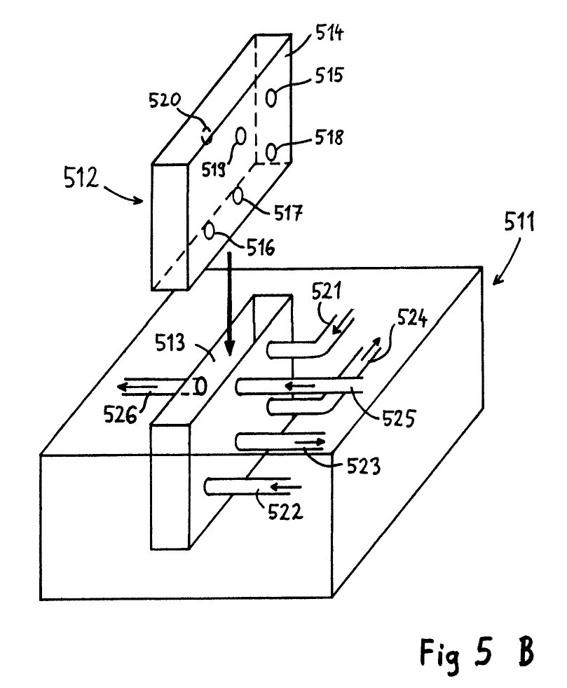

FIG. 5A shows another way for fluidically coupling a first fluidic module 500 and a second fluidic module 501. The second fluidic module 501 comprises a fluidic connecting piece 502 with a plurality of fluid ports 503 which are located on a sidewall 504 of the fluidic connecting piece 502. When the second fluidic module 501 is placed on top of the first fluidic module 500, the fluidic connecting piece 502 is slid into a corresponding receptacle 505 of the first fluidic module 500. The receptacle 505 comprises a plurality of fluid ports 506 located at positions that correspond to the positions of the fluid ports 503. Each of the fluid ports 506 may be fluidically coupled with a corresponding fluid conduit 507, 508. Thus, after the fluidic connecting piece 502 has been inserted into the receptacle 505, a plurality of fluidic connections are set up between the first fluidic module 500 and the second fluidic module 501. The first fluidic module 500 may further comprise some kind of clamping mechanism (not shown) for fastening the fluidic connecting piece 502 after it has been inserted into the receptacle 505.

The first fluidic module 500 may further comprise one or more optical transmitter and/or receiver elements 509 located at the upper surface of the first fluidic module 500. Correspondingly, the second fluidic module 501 may comprise one or more optical receiver and/or transmitter elements 510 located at the bottom side of the second fluidic module 501. When the second fluidic module 501 is placed on top of the first fluidic module 500, one or more optical transmission paths are established between the two modules. Via the optical transmission paths, data may be transmitted in both directions between the first fluidic module 500 and the second fluidic module 501.

Alternatively or additionally, the first fluidic module 500 and the second fluidic module 501 may both comprise electrical connectors that provide one or more electrical connections between the fluidic modules when the second fluidic module 501 is placed on top of the first fluidic module 500.

FIG. 5B shows another embodiment of the invention. According to this embodiment, a second fluidic module 512 is inserted into a receptacle 513 of a first fluidic module 511. A side wall 514 of the second fluidic module 512 comprises two fluid inlets 515, 516 and two fluid outlets 517, 518. Furthermore, the second fluidic module 512 comprises a first optical joint 519 and a second optical joint 520 located at the opposite side of the first optical joint 519. When the second fluidic module 512 is inserted into the first fluidic module 511, fluidic connections are set up between fluid conduits 521, 522 and the fluid inlets 515,516. Via the fluid conduits 521, 522, different kinds of fluid may be supplied to the second fluidic module 512. Furthermore, fluidic connections are set up between the fluid outlets 517, 518 and the fluid conduits 523, 524. Via the fluid conduits 523, 524, fluids may be withdrawn from the second fluidic module 512. When the second fluidic module 512 is slid into the receptacle 513, a first optical fiber 525 adapted for supplying light is pressed against the first optical joint 519, and a second optical fiber 526 is pressed against the second optical joint 520.

The fluidic module may e.g. comprise a fluid cell, with fluid being passed through the flow cell. For analysing properties of a fluid passing trough the fluid cell, light provided by the first optical fiber 525 may e.g. be transmitted through the fluid cell. The transmitted light may be carried to a detection unit via the second optical fiber 526, with the detection unit being adapted for analysing the transmitted light.

The first fluidic module 511 may further comprise some kind of clamping mechanism (not shown) for fastening the second fluidic module 512 after it has been inserted into the receptacle 513. The clamping mechanism may be helpful both for establishing fluid-tight fluidic connections and for establishing an improved optical coupling between the optical joints 519, 520 and the optical fibers 525, 526.

In contrast to the optical signals exchanged between the transmitter and/or receiver elements 509 and 510 shown in FIG. 5A, the optical signal received by the optical fiber 526 is an intensity signal, with the information carried by the optical signal being the signal's intensity. For this reason, the optical junctions should be implemented in a way that light can be coupled to and decoupled from the second fluidic module 512 without being strongly attenuated or degraded.

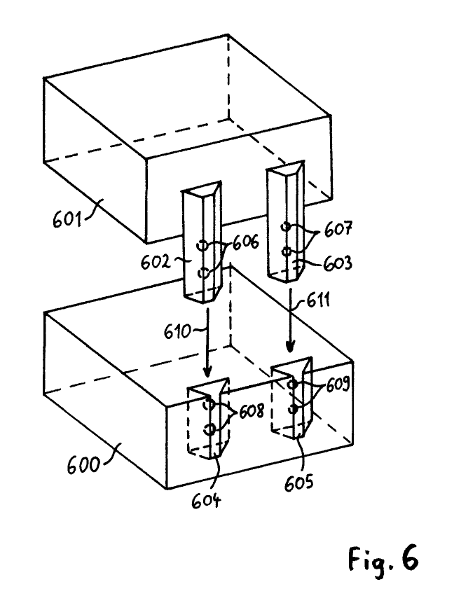

FIG. 6 shows a first fluidic module 600 and a second fluidic module 601 which are fluidically connected via two dovetail joints. The respective tails 602, 603 of the dovetail connections are located at the rear side of the second fluidic module 601. The tails 602, 603, which protrude in a downward direction, are adapted for engaging with corresponding sockets 604, 605 located at the rear side of the first fluidic module 600. The tail 602 comprises two fluid ports 606, which are indicated with dashed lines, and the tail 603 also comprises two fluid ports 607. Correspondingly, the socket 604 comprises two fluid ports 608, and the socket 605 comprises two fluid ports 609. When the second fluidic module 601 is placed on top of the first fluidic module 600, the tails 602, 603 are slid into the corresponding sockets 604, 605 of the dovetail joints, as indicated by arrows 610 and 611. Now, the positions of the fluid ports 606 match with the positions of the fluid ports 608. The positions of the fluid ports 607 match with the positions of the fluid ports 609. Due to the geometry of the dovetail joints, the fluid ports 606 are tightly pressed against the fluid ports 608, and the fluid ports 607 are tightly pressed against the fluid ports 609. Via the fluid ports 606 to 609, a plurality of fluid tight fluidic connections are established between the fluidic modules 600 and 601.

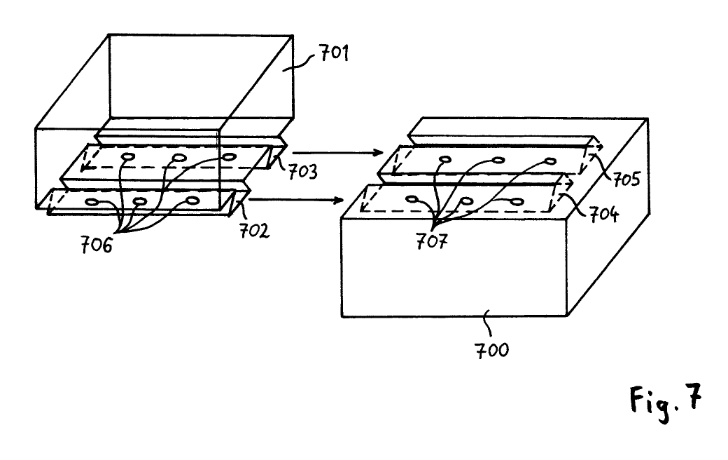

FIG. 7 shows another embodiment of the present invention, whereby a first fluidic module 700 and a second fluidic module 701 are fluidically connected via two dovetail joints. The respective tails 702, 703 of the dovetail joints are attached to the lower side of the second fluidic module 701, whereas the corresponding sockets 704, 705 are integrally cast into the upper side of the first fluidic module 700. The tails 702, 703 are adapted for engaging with the sockets 704, 705. When the second fluidic module 701 is slid onto the first fluidic module 700, the tails 702, 703 engage with the corresponding sockets 704, 705 of the dovetail joints. Each of the tails 702, 703 comprises a set of fluid ports 706, and each of the sockets 704, 705 comprises a set of corresponding fluid ports 707. After the tails 702, 703 have been slid into the sockets 704, 705, the fluid ports 706 are located at positions that match with the positions of the fluid ports 707.

Preferably, the sockets 704, 705 are slightly tapered towards the respective rear ends of the dovetail joints. When the tails 702, 703 are slid into the corresponding sockets 704, 705, the joint becomes tighter as a finished position is reached. The fluid ports 706 are tightly pressed against the corresponding fluid ports 707, and fluid tight fluidic connections are set up between the first fluidic module 700 and the second fluidic module 701.

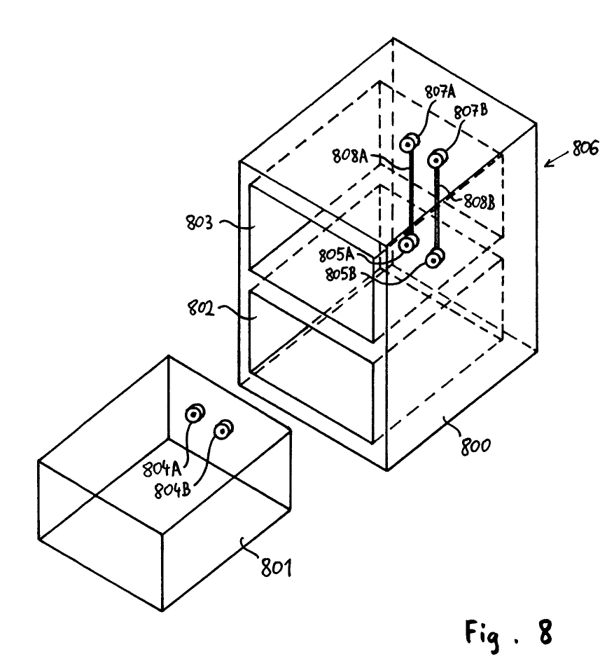

In FIG. 8, an embodiment is shown where fluidic connections are set up between a rack 800 and a fluidic module 801 that is put into the rack. The rack 800 comprises two slots 802, 803, with each of the slots being adapted for accommodating a fluidic module. For example, the fluidic module 801 may be slid into the slot 802 of the rack 800. The fluidic module 801 comprises two fluidic connectors 804A, 804B located at the rear side of the fluidic module's encasement. The rack 800 comprises two corresponding fluidic connectors 805A, 805B, which are located at the rear side of the slot 802. The fluidic connectors 804A, 804B are realized as protrusions, whereas the fluidic connectors 805A, 805B are realized as indentations. When the fluidic module 801 is slid into the slot 802 of the rack 800, the fluidic connectors 804A, 804B engage with the corresponding fluidic connectors 805A, 805B, and fluidic connections are set up between the fluidic module 801 and the back panel 806 of the rack 800.

In addition to the fluidic connectors 805A, 805B located at the rear side of the slot 802, the back panel 806 comprises fluidic connectors 807A, 807B located at the rear side of the slot 803. The fluidic connectors 807A, 807B are adapted for providing fluidic connections with a fluidic module in the slot 803. The back plane 806 further comprises fluid conduits 808A, 808B for interconnecting fluidic connectors of the back panel 806. For example, the fluid conduit 808A connects the fluidic connectors 805A and 807A, and the fluid conduit 808B connects the fluidic connectors 805B and 807B. The fluidic connectors and fluid conduits of the back panel 806 provide fluidic interconnections between fluidic modules that are slid into the slots 802, 803 of the rack 800. The required fluidic interconnections are automatically set up when the fluidic modules are slid into the respective slots 802, 803 of the rack 800.

1. A fluidic module comprising
a fluidic connector having a fluid port and being located at the bottom side of the fluidic module,
wherein, when the fluidic module is placed on top of a further fluidic module, the fluidic connector is in contact with a further fluidic connector of said further fluidic module, and a fluid tight fluidic connection is established between said fluid port and a corresponding fluid port of said further fluidic connector.

2. The fluidic module of claim 1, further comprising at least one of:
the fluid tight fluidic connection is accomplished by a contact pressing force that presses the fluidic connector against the further fluidic connector of said further fluidic module;
the fluidic connector comprises a guide sleeve;
the fluidic connector comprises a self-aligning guide sleeve.

3. A fluidic module, with
a fluidic connector located at the bottom side or at the rear side of the fluidic module, the fluidic connector comprising a fluid port,
wherein, when the fluidic module is slid onto a further fluidic module, the fluidic connector engages with a further fluidic connector of said further fluidic module, and a fluid tight fluidic connection is established between said fluid port and a corresponding fluid port of said further fluidic connector.

4. The fluidic module of claim 1, further comprising at least one of:
the fluid tight fluidic connection is accomplished by a contact pressing force that presses the fluidic connector against the further fluidic connector of said further fluidic module;
the fluidic module further comprises a spring element adapted for pressing the fluidic connector against the further fluidic connector of said further fluidic module;
the fluidic connector is realized as a tail or a socket of a dovetail joint;
the fluidic connector is realized as a tail or a socket of a dovetail joint, the dovetail joint being adapted for establishing the fluid tight fluidic connection between the fluidic connector and the further fluidic connector of said further fluidic module.

5. A fluidic module, with
a fluidic connector located at the bottom side or at the rear side of the fluidic module, the fluidic connector comprising a fluid port,
wherein, when the fluidic module is put in a rack adapted for mounting two or more fluidic modules, the fluidic connector is pressed against a further fluidic connector of said rack, and a fluid tight fluidic connection is established between said fluid port and a further fluid port of said further fluidic connector.

6. The fluidic module of claim 5, further comprising at least one of:
the fluid tight fluidic connection is accomplished by a contact pressing force that presses the fluidic connector against the further fluidic connector of said rack;
the fluidic module further comprises a spring element adapted for pressing the fluidic connector against the further fluidic connector of said rack;
the fluidic connector comprises a guide sleeve;
the fluidic connector comprises a self-aligning guide sleeve;
the fluidic connector is realized as a tail or a socket of a dovetail joint;
the fluidic connector is realized as a tail or a socket of a dovetail joint, the dovetail joint being adapted for establishing the fluid tight fluidic connection between the fluidic connector and the further fluidic connector of said rack.

7. A fluidic system comprising
a first fluidic module, the first fluidic module comprising a first fluidic connector located at the upper side of the first fluidic module, the first fluidic connector comprising a first fluid port,
a second fluidic module comprising a second fluidic connector located at the bottom side of the second fluidic module, the second fluidic connector comprising a second fluid port,
wherein, when the second fluidic module is placed on top of the first fluidic module, the second connector is in contact with the first connector, wherein the first and the second fluidic connector are adapted for establishing a fluid tight fluidic connection between the first fluid port and the second fluid port.

8. The fluidic system of claim 7, further comprising at least one of:
the second fluidic connector is implemented as a counterpart of the first fluidic connector;
the second fluidic connector is a complementary connector to the first fluidic connector;
when the second fluidic module is placed on top of the first fluidic module, the first and the second fluidic connector are adapted for automatically establishing a fluid tight fluidic connection between the first fluid port and the second fluid port.

9. The fluidic system of claim 7, further comprising at least one of:
the fluid tight fluidic connection is accomplished by a contact pressing force that presses the second fluidic connector of the second fluidic module against the first fluidic connector of the first fluidic module;
the fluid tight fluidic connection is accomplished by a contact pressing force that presses the second fluidic connector of the second fluidic module against the first fluidic connector of the first fluidic module, wherein the contact pressing force is exerted by the second fluidic module's weight.

10. The fluidic system of claim 7, further comprising at least one of:
at least one of the first and the second fluidic module comprises a clamping member adapted for pressing the second fluidic module against the first fluidic module;
at least one of the first and the second fluidic module comprises a clamping member, wherein a clamping force exerted by the clamping member is adapted for pressing the second fluidic connector of the second fluidic module against the first fluidic connector of the first fluidic module;
the fluid tight fluidic connection is fluid tight at a fluid pressure of up to 1500 bar;
at least one of the fluidic connectors comprises a sealing element, preferably a rubber gasket, located around the fluid port of said at least one fluidic connector;
the fluidic connectors are substantially made of one or more of: PEEK, ceramics, teflon;
at least one of the fluidic connectors comprises a sealing face;
at least one of the fluidic connectors comprises a sealing face, the sealing face being made of one of: PEEK, ceramics, teflon, gold, a ductile metal.

11. The fluidic system of claim 7, further comprising at least one of:
one of the fluidic connectors is realized as a protrusion, and a corresponding fluidic connector of the respective other fluidic module is realized as a complementary indentation adapted for accepting the protrusion;
one of the fluidic connectors is realized as a protrusion, and a corresponding fluidic connector of the respective other fluidic module is realized as a complementary indentation adapted for accepting the protrusion, wherein the protrusion engages with the complementary indentation when the second fluidic module is placed on top of the first fluidic module.

12. The fluidic system of claim 7, wherein at least one of the fluidic connectors comprises a guide sleeve.

13. The fluidic system of claim 12, further comprising at least one of:
the guide sleeve is realized as a self-aligning guide sleeve;
the guide sleeve of a fluidic connector is adapted for being caught by a corresponding fluidic connector of the respective other fluidic module;
the guide sleeve of a fluidic connector is laterally movable to adjust to a position of a corresponding fluidic connector of the respective other fluidic module;
the fluidic connector comprising the guide sleeve further comprises a spring element adapted for pressing the guide sleeve against a corresponding fluidic connector of the respective other fluidic module;
the fluidic connector comprising the guide sleeve further comprises a spring element adapted for pressing the guide sleeve against a corresponding fluidic connector of the respective other fluidic module, wherein the spring element is one of: a cup spring, a plate spring, a disk spring, a spring collar, a coil spring.

14. The fluidic system of claim 7, further comprising at least one of:
the first fluidic module comprises an electrical connector, the second fluidic module comprises an electrical connector, and the electrical connectors are adapted for providing an electrical connection between the second fluidic module and the first fluidic module;
the first fluidic module comprises an optical connector, the second fluidic module comprises an optical connector, and the optical connectors are adapted for providing an optical connection between the second fluidic module and the first fluidic module;
the first and the second fluidic module contain fluidic system components of the fluidic system;
the first and the second fluidic module contain fluidic system components of the fluidic system, wherein the fluidic system components comprise one or more of: a pump, a pumping system, a preparative pump, a binary pump, a quaternary pump, a degassing unit, an autosampling unit, a purification system, a sample preparation system, a thermostatted column compartment, a sample separation system, a fraction collector, a mass spectroscopy unit, a variable wavelength detector, a multiple wavelength detector, a diode array detector, a fluorescence detector, a refractive index detector;
the fluidic system is one of: a liquid chromatography system, an HPLC system, an electrophoresis system, an electrochromatography system.

15. A fluidic system comprising
a first fluidic module, the first fluidic module comprising a first fluidic connector located at the upper side or at the rear side of the first fluidic module, the first fluidic connector comprising a first fluid port,
a second fluidic module comprising a second fluidic connector located at the bottom side or at the rear side of the second fluidic module, the second fluidic connector comprising a second fluid port,
wherein, when the second fluidic module is slid onto the first fluidic module, the second connector is adapted for engaging with the first connector, and the first and the second fluidic connector are adapted for establishing a fluid tight fluidic connection between the first fluid port and the second fluid port.

16. The fluidic system of claim 15, further comprising at least one of:
the second fluidic connector is implemented as a counterpart of the first fluidic connector;
the second fluidic connector is a complementary connector to the first fluidic connector;
when the second fluidic module is slid onto the first fluidic module, the first and the second fluidic connector are adapted for automatically establishing a fluid tight fluidic connection between the first fluid port and the second fluid port.

17. The fluidic system of claim 15, further comprising at least one of:
the fluid tight fluidic connection is accomplished by a contact pressing force that presses one of the fluidic connectors against a corresponding fluidic connector of the respective other fluidic module;
the fluid tight fluidic connection is accomplished by a contact pressing force that presses one of the fluidic connectors against a corresponding fluidic connector of the respective other fluidic module, wherein the contact pressing force is exerted by a spring element;
the fluid tight fluidic connection is accomplished by a contact pressing force that presses one of the fluidic connectors against a corresponding fluidic connector of the respective other fluidic module, wherein the contact pressing force is exerted by a spring element,
wherein the spring element is one of: a cup spring, a plate spring, a disk spring, a spring collar, a coil spring.

18. The fluidic system of claim 15, wherein one of the fluidic connectors is realized as a tail of a dovetail joint, and a corresponding fluidic connector of the respective other fluidic module is realized as a socket of the dovetail joint.

19. The fluidic system of claim 18, further comprising at least one of:
the dovetail joint is assembled by sliding the tail into the socket;
the tail comprises a fluid port, the socket comprises a corresponding fluid port, and a fluidic connection is established when the tail engages with the socket;
the dovetail joint is adapted for establishing a fluid tight fluidic connection between the first fluidic module and the second fluidic module when the second fluidic module is slid onto the first fluidic module;
the tail is located at the bottom side of the second fluidic module, the socket is located at the upper side of the first fluidic module, and the tail engages with the socket when the second fluidic module is slid onto the first fluidic module;
the tail is located at the rear side of the second fluidic module and protrudes downwards, the socket is located at the rear side of the first fluidic module, and the tail engages with the socket when the second fluidic module is slid onto the first fluidic module;
the socket is slightly tapered towards the rear end of the dovetail joint, and the joint becomes tighter as a finished position is reached.

20. The fluidic system of claim 15, further comprising at least one of:
the first fluidic module comprises an electrical connector, the second fluidic module comprises an electrical connector, and the electrical connectors are adapted for providing an electrical connection between the second fluidic module and the first fluidic module;
the first fluidic module comprises an optical connector, the second fluidic module comprises an optical connector, and the optical connectors are adapted for providing an optical connection between the second fluidic module and the first fluidic module;
the first and the second fluidic module contain fluidic system components of the fluidic system;
the first and the second fluidic module contain fluidic system components of the fluidic system, wherein the fluidic system components comprise one or more of: a pump, a pumping system, a preparative pump, a binary pump, a quaternary pump, a degassing unit, an autosampling unit, a purification system, a sample preparation system, a thermostatted column compartment, a sample separation system, a fraction collector, a mass spectroscopy unit, a variable wavelength detector, a multiple wavelength detector, a diode array detector, a fluorescence detector, a refractive index detector;
the fluidic system is one of: a liquid chromatography system, an HPLC system, an electrophoresis system, an electrochromatography system.

21. A fluidic system comprising
a rack adapted for mounting two or more fluidic modules, the rack comprising a first fluidic connector with a first fluid port,
a fluidic module comprising a second fluidic connector located at the bottom side or at the rear side of the fluidic module, the second fluidic connector comprising a second fluid port,
wherein, when the fluidic module is put in the rack, the second connector is in contact with the first connector, wherein the first and the second fluidic connector are adapted for establishing a fluid tight fluidic connection between the first fluid port and the second fluid port.

22. The fluidic system of claim 21, further comprising at least one of:
the second fluidic connector is implemented as a counterpart of the first fluidic connector,
the second fluidic connector is a complementary connector to the first fluidic connector,
when the fluidic module is put in the rack, the first and the second fluidic connector are adapted for automatically establishing a fluid tight fluidic connection between the first fluid port and the second fluid port.

23. The fluidic system of claim 21, further comprising at least one of:
the fluid tight fluidic connection is accomplished by a contact pressing force that presses the second fluidic connector of the fluidic module against the first fluidic connector of the rack;
the fluid tight fluidic connection is accomplished by a contact pressing force that presses the second fluidic connector of the fluidic module against the first fluidic connector of the rack, the contact pressing force being exerted by a spring element;
the fluid tight fluidic connection is accomplished by a contact pressing force that presses the second fluidic connector of the fluidic module against the first fluidic connector of the rack, the contact pressing force being exerted by a spring element, wherein the spring element is one of: a cup spring, a plate spring, a disk spring, a spring collar, a coil spring.

24. The fluidic system of claim 21, further comprising at least one of:
the rack comprises a back panel, the back panel comprising the first fluidic connector;
the rack comprises a back panel, the back panel comprising a fluid conduit adapted for providing a fluidic connection between two or more fluidic modules mounted in the rack;
the fluidic system comprises a clamping member adapted for pressing the fluidic module against a back panel of the rack with a certain contact pressing force.

25. The fluidic system of claim 21, further comprising at least one of:
the rack comprises an electrical connector, the fluidic module comprises an electrical connector, and the electrical connectors are adapted for providing an electrical connection between the fluidic module and the rack;
the rack comprises an optical connector, the fluidic module comprises an optical connector, and the optical connectors are adapted for providing an optical connection between the fluidic module and the rack;
the fluidic module contains fluidic system components of the fluidic system;
the fluidic module contains fluidic system components of the fluidic system, wherein the fluidic system components comprise one or more of: a pump, a pumping system, a preparative pump, a binary pump, a quaternary pump, a degassing unit, an autosampling unit, a purification system, a sample preparation system, a thermostatted column compartment, a sample separation system, a fraction collector, a mass spectroscopy unit, a variable wavelength detector, a multiple wavelength detector, a diode array detector, a fluorescence detector, a refractive index detector;
the fluidic system is one of: a liquid chromatography system, an HPLC system, an electrophoresis system, an electrochromatography system.
